(19) United States
(12) Patent Application Publication
(10) Pub. No.: US 2015/0154566 A1
(43) Pub. Date: Jun. 4, 2015

(54) PRODUCTIVITY BASED MEETING SCHEDULER

(71) Applicant: VMWARE, INC., Palo Alto, CA (US)

(72) Inventor: SIDHARTH SAXENA, Palo Alto, CA (US)

(73) Assignee: VMWARE, INC., Palo Alto, CA (US)

(21) Appl. No.: 14/094,825

(22) Filed: Dec. 3, 2013

(51) Int. Cl. G06Q 10/10

(52) U.S. Cl. CPC G06Q 10/1095

(57) ABSTRACT

Techniques for scheduling a meeting using a productivity based meeting scheduler are described. In one example embodiment, the productivity based scheduler receives selection of two or more participants for a meeting requested by a meeting organizer. The selection received on a calendar application is then executed on one or more client devices. Participant information associated with each selected participant is then determined. A time value of each selected participant is then computed based on the determined participant information. The computed time value of each selected participant is then displayed on at least one display screen of a client device by the calendar application. The productivity based scheduler then receives a request to schedule the meeting based on displayed computed time value of each selected participant. The meeting is then scheduled based on the received request.

### BACKGROUND

In today's workplace, too-few-meetings is probably an alien concept. Further, today's workplace and nature of work involves frequent collaborations with large number of colleagues, managers, direct reports and so on. For many projects, meetings are the starting-point, working-ground and also an end-point. There are planning meetings, working meetings, review meetings, staff meetings, and often meetings to discuss future meetings.

Various productivity systems and software packages exist for assisting in scheduling meetings in large enterprise environments. These systems of software applications are generally focused on assuring availability of individuals and ordinarily include or rely on a calendar for the respective individuals. Normally, these systems are designed to provide meeting notices with certain meeting particulars, such as topic, time and location to the participants and may update the individuals' calendar. Further, these systems may provide reminder messages that are automatically sent to the individuals a fixed amount of time prior to the meeting.

Typically, time is money and especially, for a product company, time spent in inefficient meetings may be time away from actual value addition to the company products. The meeting overload problem is compounded even further for an individual contributor, whose job success may depend on delivering the results. More meetings mean less time available to complete the tasks successfully and timely. Moreover, many meeting organizers may add more attendees than what is needed to accomplish their goals. This may result in a bigger impact when the same participants are invited for future follow-up meetings, thus triggering a cascading effect that can linger for longer periods of time until the projects are completed. Further, this may result in enormous usage of human capital over time. In addition, there is a social tendency to get a tacit approval from the largest possible colleague base, i.e., “keeping everyone in the loop”.

Existing productivity tools do not provide techniques to meeting organizers, to account for value of time they want their colleagues to commit for meetings. Further, there are no quantifiable metrics in existing calendar systems, which can convey value of attendees' time, or the total hours an employee spends in meetings. Furthermore, there are no insights aggregated at the manager level or executive level. In addition, existing techniques lack needed metrics that may be of value to the meeting organizers in assisting in balancing their demand for colleague's time. Also, existing calendar tools allow with a few clicks let meeting organizers consume vast time-blocks on their colleague's calendars, without conveying the financial cost of their decision to the meeting organizer.

### BRIEF DESCRIPTION OF THE DRAWINGS

FIG. 1 is a block diagram illustrating a system for productivity based meeting scheduler, according to an example embodiment.

FIGS. 2A and 2B are flow diagrams of process for productivity based meeting scheduling, according to an example embodiment.

FIG. 3 is a screenshot showing an interface to schedule a meeting by a meeting organizer using the productivity based meeting scheduler, according to an example embodiment.

FIG. 4 is a screenshot showing an interface for a user's calendar, including value of every hour of time-block, according to an example embodiment.

FIGS. 5-9 are screenshots showing user's (for example, employee, manager and executive) dashboards including meeting chargeback costs, collaboration scores, cluster of physical locations of meetings, and how each of these employees compare with their colleagues and peers in a company in terms of meeting efficiency, according to an example embodiment.

FIG. 10 is a block diagram of a computing system for the productivity based meeting scheduler, according to an example embodiment.

### DETAILED DESCRIPTION

Embodiments described herein provide productivity based meeting scheduling. The productivity based meeting scheduler may be incorporated into a calendar application and/or a calendar tool. The productivity based meeting scheduler makes meeting organizers more aware of the impact of their meetings and can potentially make meetings more efficient, and thereby resolving or improving the meetings overload issues previously described. The productivity based meeting scheduler accomplishes this by using a computed or estimated employee time value in actual monetary terms (e.g., U.S. dollar value), enhancements to calendar/meeting tools and chargeback dashboards for employees, managers, and executives.

Example embodiments provide the productivity based meeting scheduler including a calendar application in each client device and a calendar tool in each virtual machine (VM) that is communicatively coupled via Internet/Intranet to each of the calendar applications. In computer science, a VM is a portion of software that, when executed on appropriate hardware, creates an environment allowing the virtualization of a host computer system. Each VM may function as a self-contained platform, running its own operating system (OS) and software applications (processes). Typically, virtualization management software (VMS) provides a centralized and extensive platform for managing virtual infrastructure. In a virtualized datacenter, there can be multiple host computing systems that are managed by the VMS. The VMS may be setup to manage each host computing system to operate either independently and/or as a group of host computing systems. Even though the productivity based meeting scheduler, including the calendar tool is described as residing in each VM (i.e., providing a virtual desktop to each user), one can envision that the calendar tool can reside in a physical machine as well (i.e., providing a physical desktop instead of a virtual desktop) and the idea is not limited to only operating in a VM environment.

In one embodiment, each calendar application residing in a client device is configured to receive a selection of two or more participants for a meeting from a meeting organizer. The calendar tool then computes a time value of each selected participant based on received participant information via the calendar applications. The calendar application then displays the computed time value of each selected participant to the meeting organizer on a display screen of an associated client device. The calendar application is then configured to receive a request from the meeting organizer to schedule the meeting based on the displayed computed time value of each selected participant. The calendar application then schedules the meeting based on the received request to schedule the meeting.

### System Overview and Examples of Operation

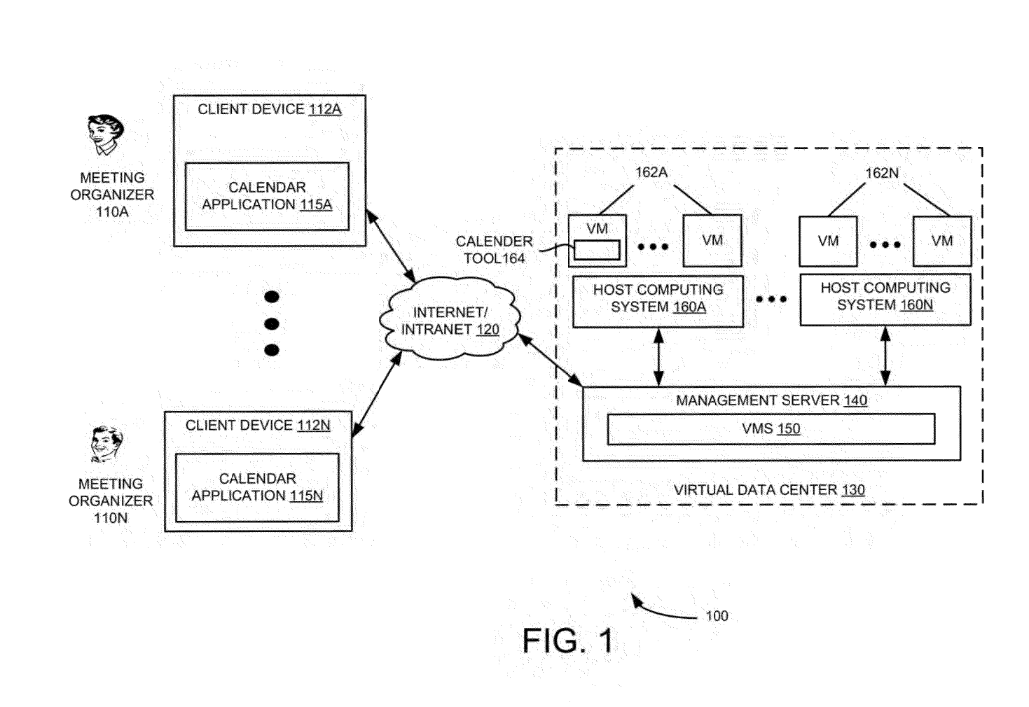

FIG. 1 is a block diagram illustrating system 100 for productivity based meeting scheduler, according to an example embodiment. As shown in FIG. 1, system 100 includes virtual datacenter 130. Virtual datacenter 130 includes host computing systems 160A-N and associated VMs 162A-N hosted by host computing systems 160A-N. Also as shown in FIG. 1, virtual datacenter 130 includes management server 140 that is communicatively coupled to host computing systems 160A-N. Further as shown in FIG. 1, management server 140 includes VMS 150. Furthermore as shown in FIG. 1, system 100 includes client devices 112 A-N and associated meeting organizers' 110A-N, respectively, that are communicatively coupled to management server 140 via Internet and/or Intranet 120. In addition as shown in FIG. 1, one or more of the VMs 162 A-N may include calendar tool 164. Also as shown in FIG. 1, one or more of the client devices 112 A-N may include calendar applications 115 A-N.

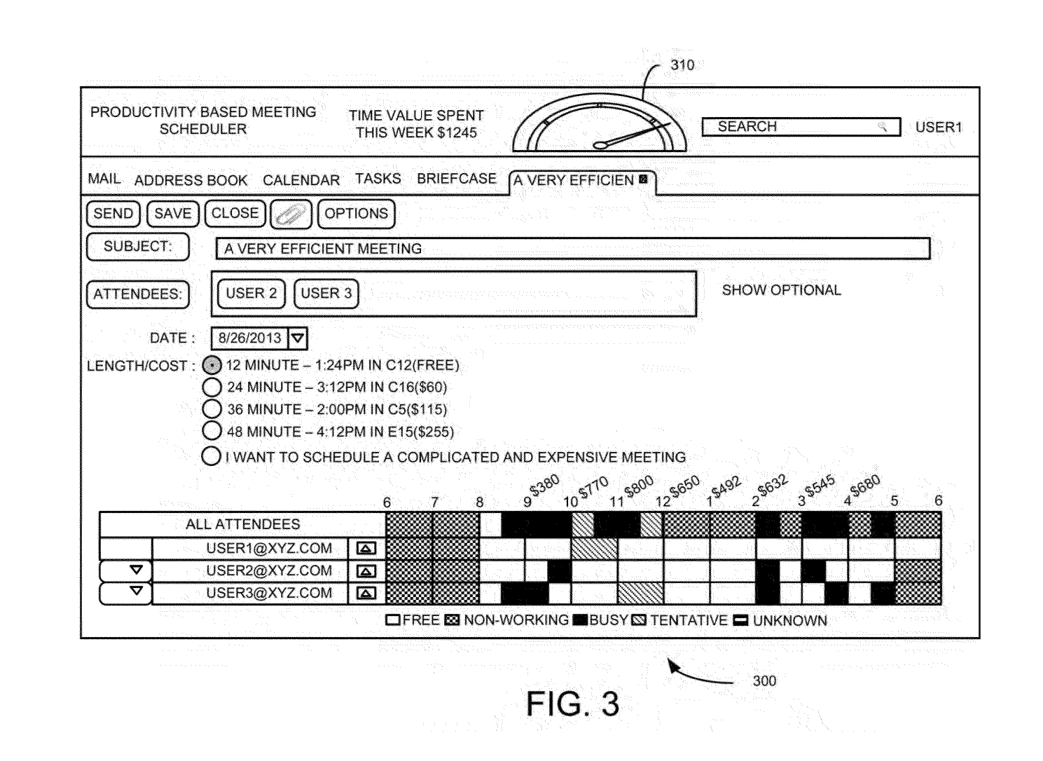

In operation, one or more of calendar applications 115A-N residing in associated one or more of client devices 112A-N receive selection of two or more participants for a meeting requested by associated meeting organizer. One or more of calendar applications 115A-N then obtain participant information, as shown in FIG. 3, associated with each selected participant from associated calendar tool 164. Example participant information is participant title, participant tenure, participant/employee role, project/task priority, physical location of participant, conflict with other tasks, calendar conflicts, time of task action and the like. Screenshot 300 in FIG. 3 shows the interface not only to the cost of scheduling the meeting based on its length, but also shows the cost of each available time-block, that can assist meeting organizers 110A-N in choosing the cheapest available time-block. Further, screenshot 300 in FIG. 3 shows meter 310 on the top of the screen that conveys a total time value spent on meetings in a current week.

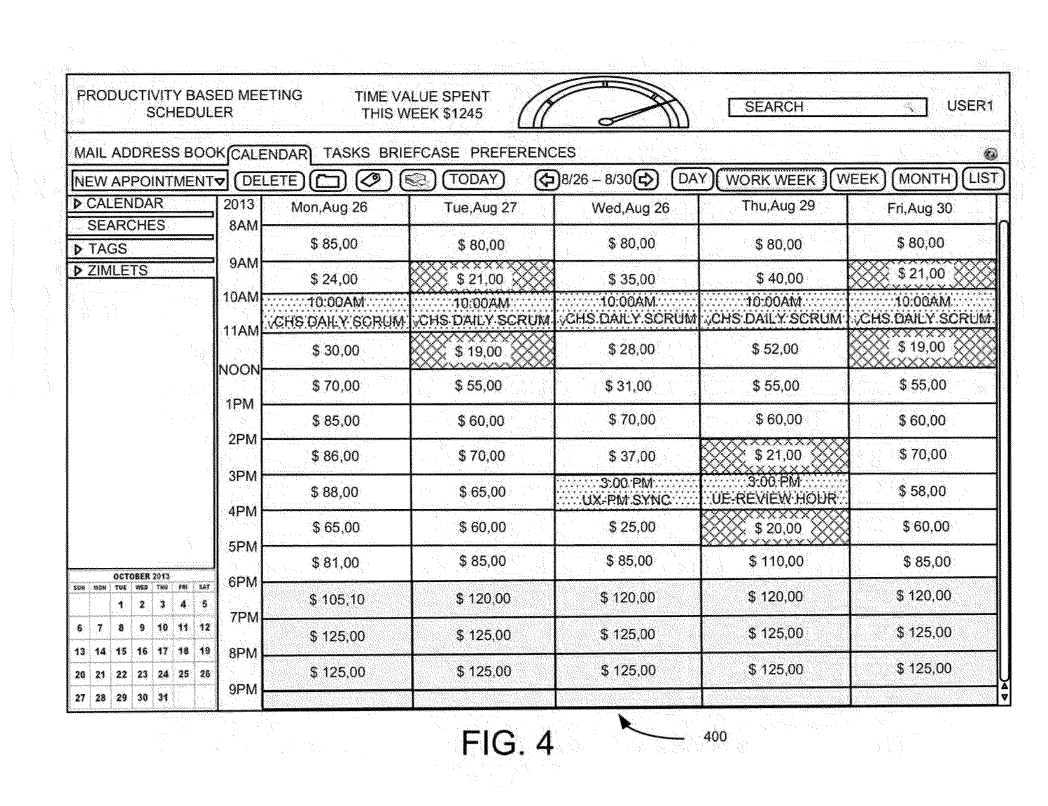

Calendar application 115 on an associated client device 112 then computes a time value of each selected participant based on the participant information. Alternatively, the time value of each selected participant may be computed by calendar tool 164, such as by communicating participant information with one another over a network, or the like. The time value computation may include information such as, whether blocks of time during odd hours are costlier, whether blocks of time with existing meetings are costlier, whether meetings related to lower priority projects are costlier, whether time of a participant with greater tenure in the company and the projects is costlier, whether meetings scheduled with employees in a department generating greater revenue are costlier, and the like. Associated one of calendar applications 115 A-N then displays the computed time value of each selected participant on a display screen of associated one of client devices 112A-N to associated one of meeting organizers 110A-N as shown in FIGS. 3-4.

Associated one of calendar applications 115A-N then receives a request from associated one of meeting organizers 110A-N to schedule the meeting based on the displayed computed time value of each selected participant. Associated one of calendar applications 115A-N then schedules the meeting based on the received request from associated one of meeting organizers 110A-N. The screenshot 400 in FIG. 4 shows the user's calendar including value of each hour of time-block along with highlighted available cheapest time slots, in order to assist meeting organizer's 110A-N to first utilize the cheaper time slots for their meetings.

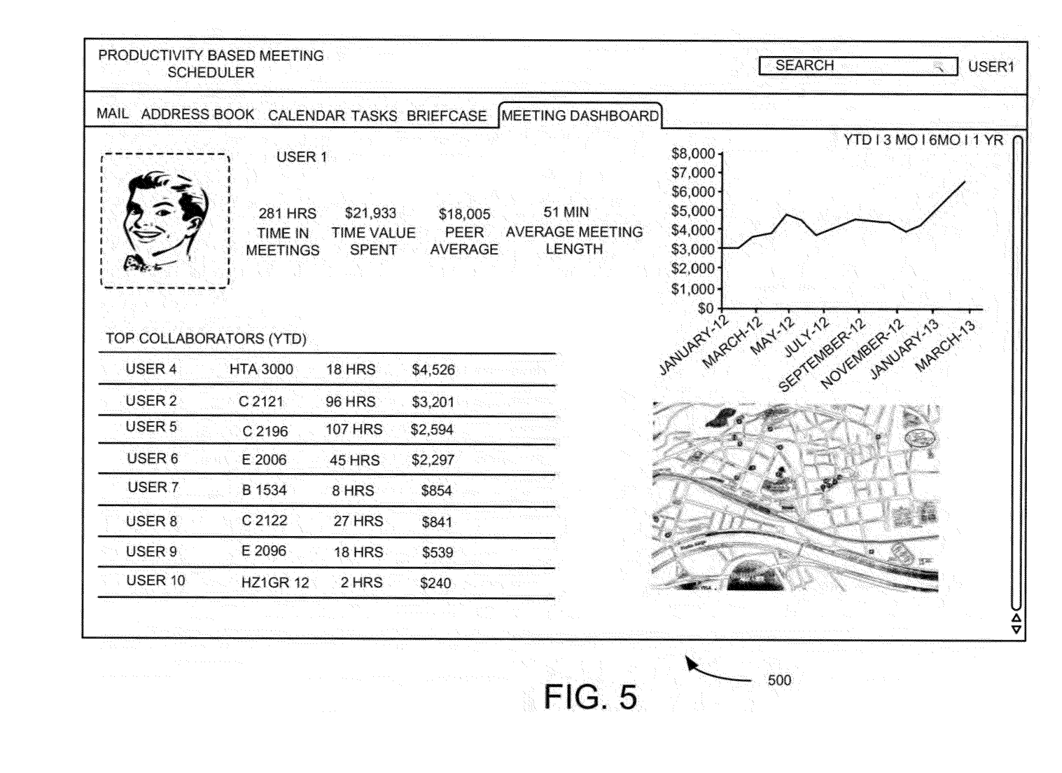

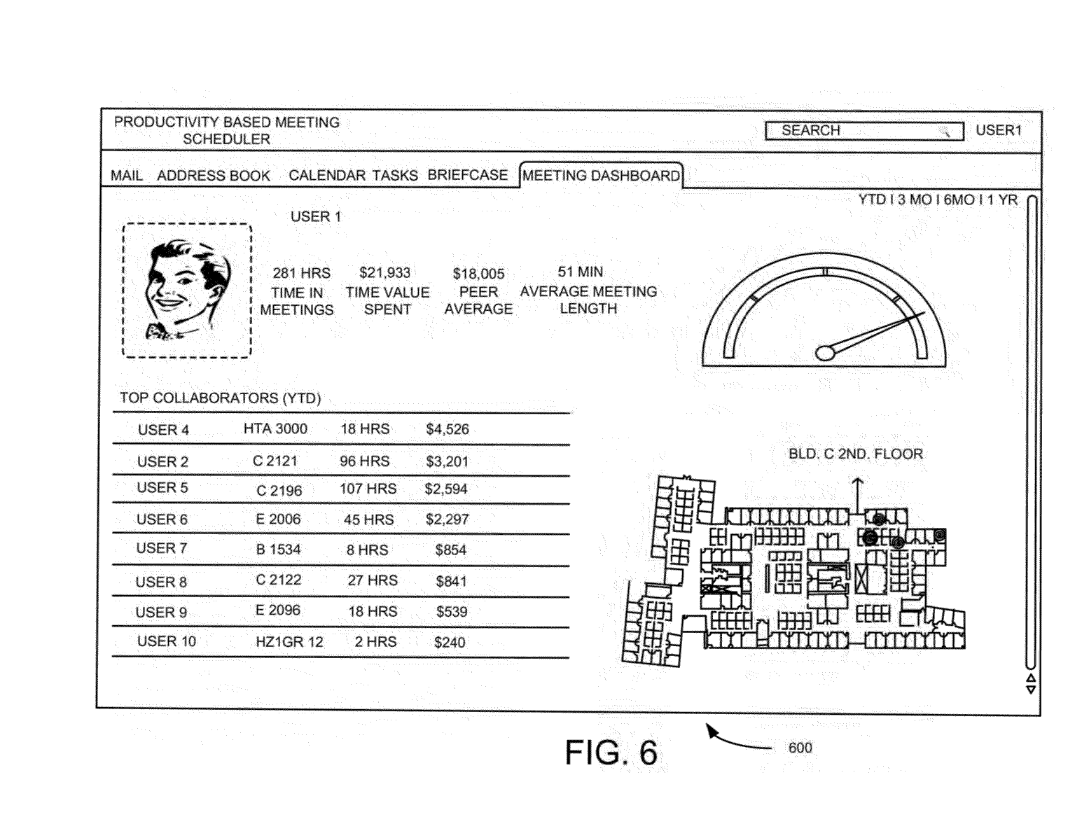

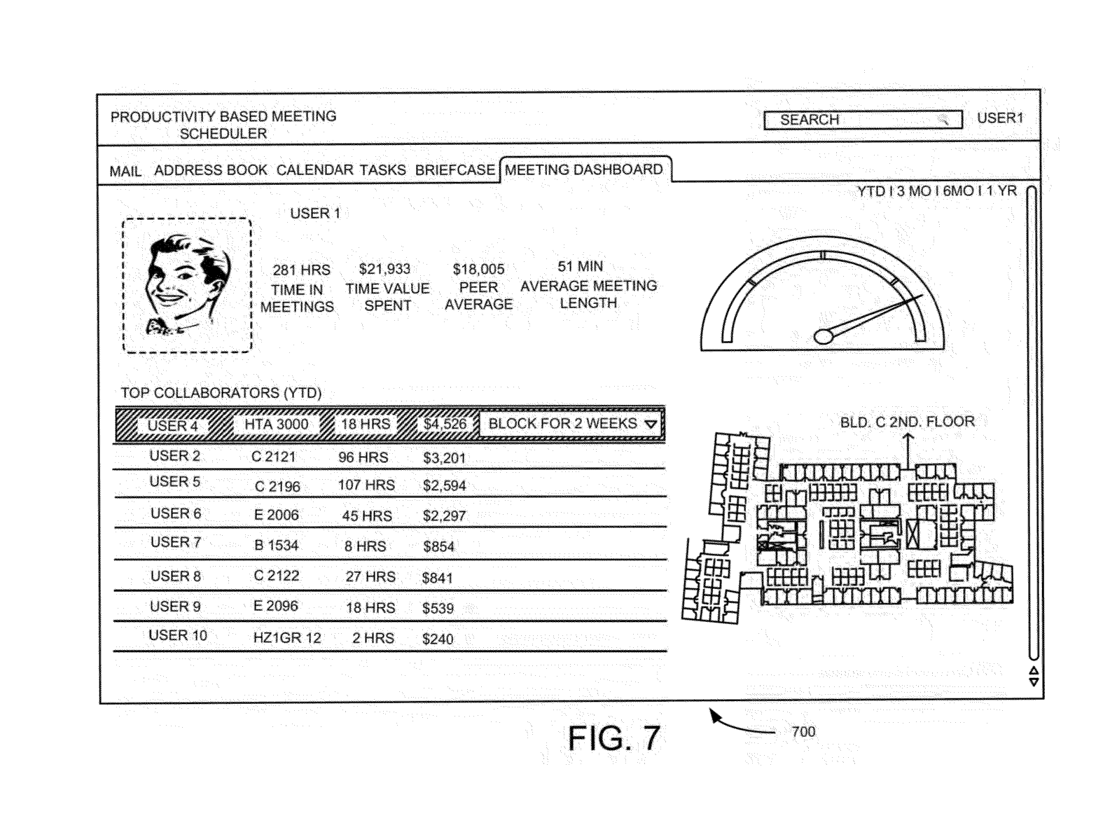

Further in operation, calendar tool 164 computes a current expense incurred upon scheduling the meeting by associated one of meeting organizers 110A-N based on the computed time value of each selected participant. Calendar tool 164 then updates a stored previous expense incurred by previously scheduled meetings by associated one of meeting organizers 110A-N with the computed current expense incurred by the scheduled meeting. Calendar tool 164 then updates a dashboard of associated one of meeting organizers 110A-N, similar to the ones shown in FIGS. 5-9, with the updated expense incurred by scheduling the meeting. Associated one of calendar applications 115A-N then displays the updated dashboard, similar to the ones shown in FIGS. 5-9, upon receiving a request from associated one of meeting organizers 110A-N to view the dashboard in the associated one of client devices 112A-N.

In some embodiments, associated one of calendar applications 115A-N determines a recommended time and location for scheduling the meeting based on the computed time value of each selected participant to associated one of meeting organizers 110A-N as shown in FIGS. 3-4. The associated one of calendar applications 115A-N then displays the recommended time and location on the display screen of associated one of client devices 112A-N. Further in some embodiments, associated one of calendar applications 115A-N determines that the computed current expense exceeds a threshold expense value. A warning message is then displayed by associated one of calendar applications 115A-N on the display screen of associated one of client devices 112 A-N in response to determining that the computed current expense exceeds the threshold expense value.

Furthermore in some embodiments, calendar tool 164 charges the computed current expense to a cost center of associated with one of meeting organizers 110A-N upon the computed current expense exceeding the threshold expense value. Also in some embodiments, calendar tool 164 displays a reward to associated one of meeting organizers 110A-N for scheduling the meeting when the computed current expense is equal to or below the threshold expense value. Example rewards may include giving a discount on future meeting costs, giving a few free meeting slots, promoting to a position on org/company-wide leader board of most efficient meeting organizers and the like. In addition in some embodiments, calendar tool 164 displays a recommendation for moving one or more selected participant's office to a different location to reduce the computed current expense based on past/prior meeting history.

Also in operation, calendar tool 164 computes a current expense incurred by scheduling the meeting by associated one of meeting organizers 110A-N associated with a supervisor based on the computed time value of each selected participant. Calendar tool 164 then updates a stored previous expense incurred by previously scheduled meetings by associated one of meeting organizers 110A-N associated with the supervisor using the computed current expense incurred by the scheduled meeting. Calendar tool 164 then updates a dashboard, such as those in FIGS. 5-9, associated with the supervisor with the updated expense incurred by scheduling the meeting by associated one of meeting organizers 110A-N associated with the supervisor. Associated one of calendar applications 115A-N then displays the updated dashboard, such as those shown in FIGS. 5-9, upon receiving a request to view the dashboard from the supervisor in associated one of client devices 112A-N.

Moreover in operation, calendar tool 164 compiles expenses incurred by remaining meeting organizers 110A-N associated with one or more other supervisors. Associated one of calendar applications 115A-N then displays the compiled expenses associated with the one or more other supervisors.

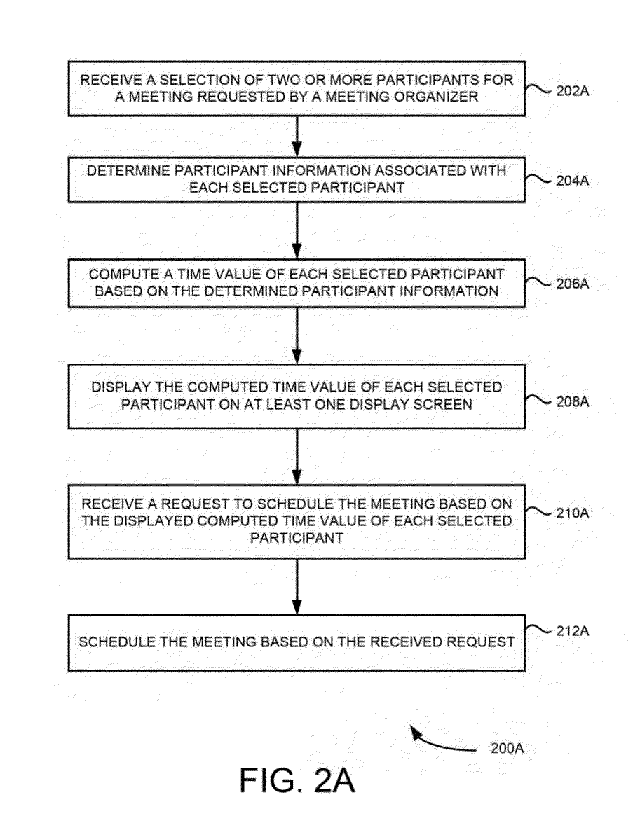

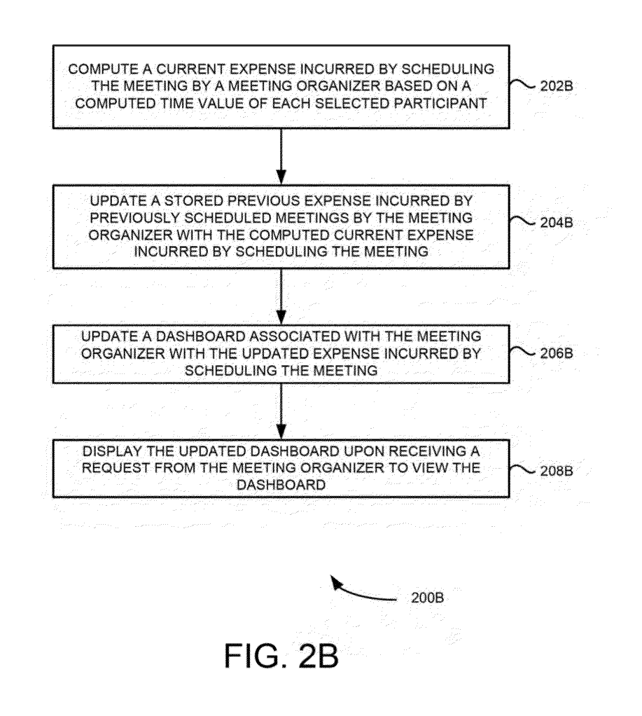

The operation of the productivity based meeting scheduling system is explained in more detail with reference to FIGS. 2A and 2B.

Also, although certain terms are used primarily herein, other terms could be used interchangeably to yield equivalent embodiments and examples. For example, the term “physical computing system” may be used interchangeably with “physical machine” or “physical device”. Further for example, it is well-known that equivalent terms in the field of system virtualization or similar or related fields could be substituted for such terms as “physical computer,” “hypervisor,” “virtual machine,” or the like. In addition, a meeting can include, for example, an event or other gathering of one or more persons for a particular purpose.

Numerous specific details are set forth herein, such as data formats and code sequences and the like, in order to provide a thorough understanding of the described techniques. The embodiments described also can be practiced without some of the specific details described herein, or with other specific details, such as changes with respect to the ordering of the logic, different logic, different architectures, or the like. Thus, the scope of the techniques and/or functions described is not limited by the particular order, selection, or decomposition of aspects described with reference to any particular routine, module, component, or the like.

### Example Processes

FIGS. 2A and 2B are flow diagrams of processes 200A and 200B, respectively, for scheduling a meeting using a productivity based meeting scheduler, according to an example embodiment. FIGS. 2A and 2B illustrate scheduling the meeting that may be performed by, for example, one or more modules of the productivity based meeting scheduler described above. The illustrated processes 200A and 200B assist in scheduling the meeting using the productivity based meeting scheduler including a calendar tool and/or a calendar application.

At block 202, the process 200A receives selection of two or more participants for a meeting requested by a meeting organizer. In these embodiments, the selection received on a calendar application is executed on one or more client devices. In some embodiments, at block 202A, the process 200A receives initial meeting composition including few or more participants. At block 204A, participant information associated with each selected participant is determined. Example participant information includes title, tenure, employee role, project/task priority, physical location, conflict with other tasks, time of task action and the like.

At block 206A, a time value of each selected participant is computed based on the participant information. In some embodiments, time value of each selected participant may be computed using a specified formula that is based on participant information, meeting parameters, or lack/availability of resources. Example time value of a selected participant can be $200 per hour, $75 per 15 minutes, and so on. The computed time value may depend on participant tenure, project priority, overheads and other such costs. In some embodiments, other participant information considered for computing the time value are a title and a position level of the employee, how long the employee has been with the company, importance of the project for which the meeting is being scheduled, day and time of meeting, conflict with another meeting, participant's role (a manager vs an individual contributor), geographical location of the participant and so on.

At block 208A, the computed time value of each selected participant is displayed on at least one display screen of a client device by the calendar application. The screenshot in FIG. 3 shows example displayed computed time values of selected participants based time of day.

At block 210A, a request to schedule the meeting based on the displayed computed time value of each selected participant is received. At block 212A, the meeting is scheduled based on the received request.

At block 202B, a current expense incurred by scheduling the meeting by the meeting organizer is computed based on the computed time value of each selected participant. At block 204B, a stored previous expense incurred by previously scheduled meetings by the meeting organizer is updated with the computed current expense incurred by the scheduled meeting by the meeting organizer. At block 206B, a dashboard associated with the meeting organizer is then updated using the updated expense incurred by the scheduled meeting. At block 208B, the updated dashboard is then displayed on the display screen of an associated client device upon receiving a request to view the dashboard by the meeting organizer. Screenshots in FIGS. 5-9 show various types of dashboards that can be displayed showing the updated expense associated with meeting organizer, meeting organizer's supervisor and other employees in similar position.

Processes 200A and 200B may perform additional operations. For example, after blocks 212A and/or 208B, according to processes 200A and 200B, a time and location for scheduling the meeting may be determined and recommended based on the computed time value of each selected participant to the meeting organizer. Further, the recommended time and location is displayed on the associated client device's display screen. Another additional operation may include determining that the computed current expense exceeds a threshold expense value and then displaying a warning message on the associated client device's display screen in response to determining that the computed expense exceeds the threshold expense value. Example warning message may include discouraging scheduling the meeting by the meeting organizer. Another additional operation may include charging the computed current expense to the meeting organizer's cost center upon the computed current expense exceeding the threshold expense value. Another additional operation may include displaying a reward to the meeting organizer on the client device's display screen for scheduling the meeting when the computed current expense is equal to or below the threshold expense value. Yet another additional operation may include displaying a recommendation for moving one or more selected participant's office to a different location to reduce the computed current expense based on past meeting history. In some embodiments, an alternative time-slot for the meeting may be suggested, which is different than the meeting organizer's original selection, based on a cheaper cost of the meeting.

In some embodiments, processes 200A and 200B may include computing a current expense incurred by scheduling the meeting by the meeting organizer associated with a supervisor/manager based on the computed time value of each selected participant. A stored previous expense incurred by previously scheduled meetings by the meeting organizer associated with the same supervisor/manager is then updated using the computed current expense incurred by the scheduled meeting. A dashboard associated with the supervisor/manager is then updated with the updated expense incurred by scheduling the meeting by the meeting organizer associated with the supervisor. The processes 200A and 200B may then be configured to display the updated dashboard upon receiving a request from the supervisor/manager to view the dashboard.

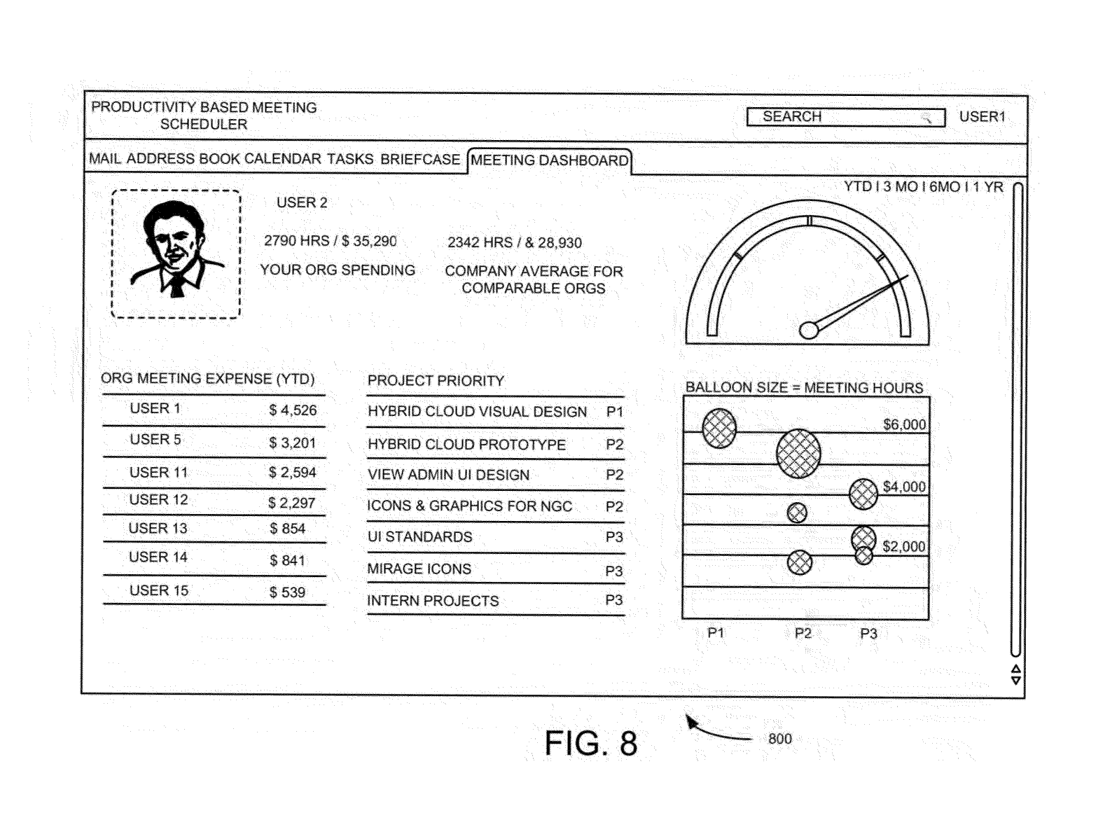

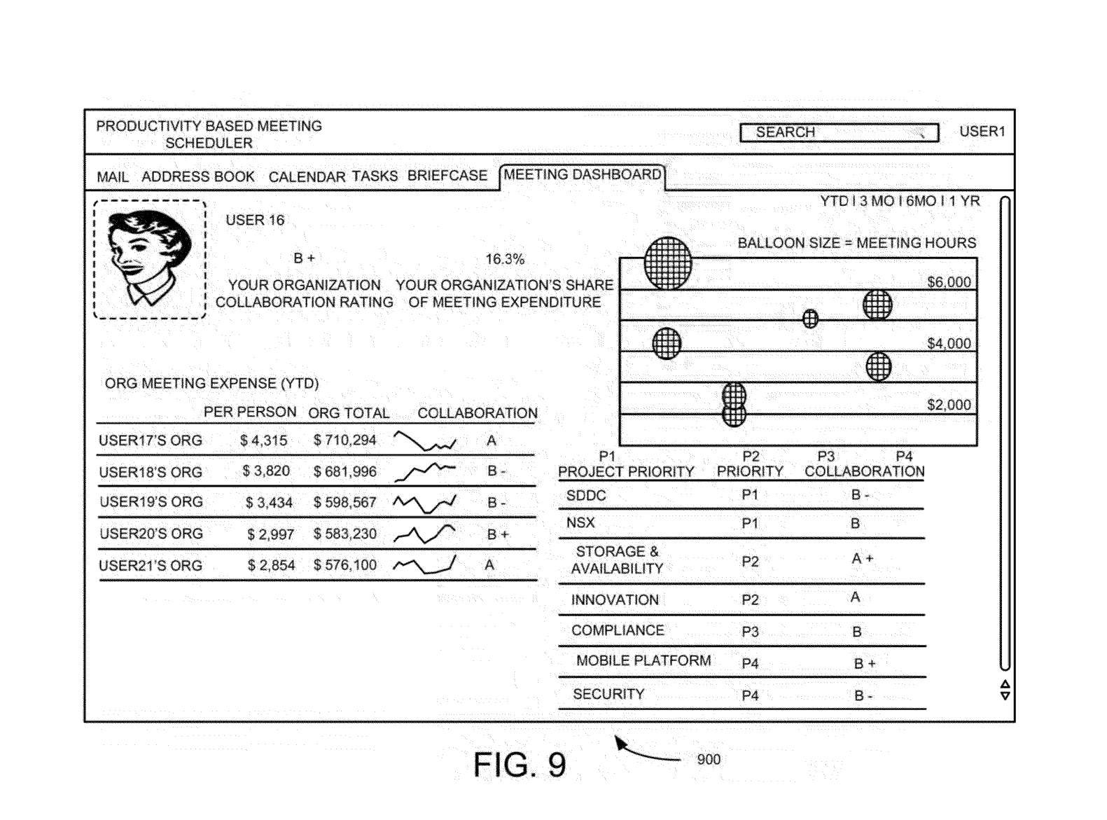

In some embodiments, processes 200A and 200B may include compiling expenses incurred by a plurality meeting organizers associated with one or more other supervisors. Further in these embodiments, the processes 200A and 200B may include displaying the complied expenses associated with the one or more other supervisors. The screenshots 800 and 900 in FIG. 8 and FIG. 9, respectively, show a dashboard including various meeting organizers incurred meeting expenses year-to-date along with a listing of project priority. Also, shown in the dashboard are meeting expenses incurred by the supervisor/manager's organization in hours and dollars versus the company average meeting expenses incurred in hours and dollars. Also, the dashboards in FIG. 8 and FIG. 9 include graphical representation of expenses incurred by the meeting organizer.

Processes 200A and 200B for scheduling a meeting using the productivity based meeting scheduler is explained in more detail above with reference to the system diagram in FIG. 1.

### Example Computing System Implementation

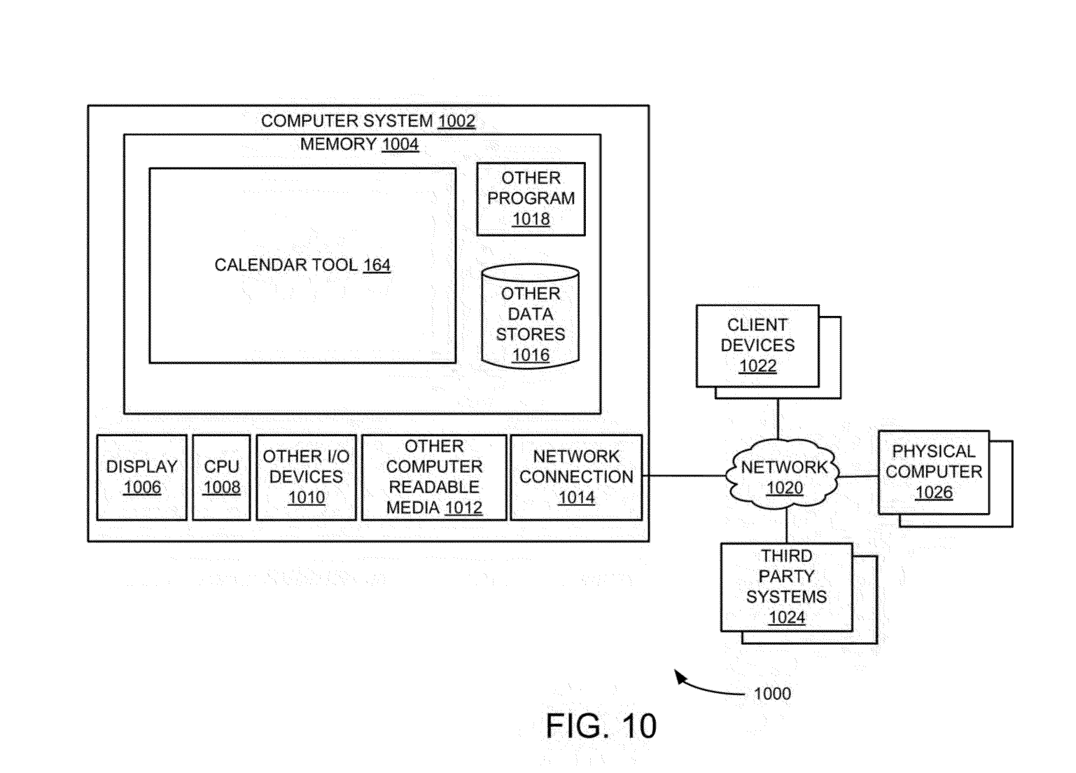

FIG. 10 is a block diagram 1000 of an example computing system for productivity based meeting scheduler, according to an example embodiment. In particular. FIG. 10 shows computing system 1002 that may be utilized to implement calendar tool 164 (shown in FIG. 1). Calendar tool 164 may be implemented in software, hardware, firmware, or in some combination to achieve the capabilities described herein.

In the embodiment shown, computing system 1002 may comprise computer memory (“memory”) 1004, display 1006, one or more central processing units (“CPU”) 1008, Input/Output devices 1010 (e.g., a keyboard, a mouse, etc.), other computer-readable media 1012, and network connections 1014. Calendar tool 164 is shown residing in memory 1004. The components of calendar tool 164 may execute on one or more CPUs 1008 and implement techniques described herein. Other code or programs 1018 (e.g., an administrative interface, a Web server, and the like) and potentially other data repositories, such as data store 1016, may also reside in memory 1004, and execute on one or more CPUs 1008. One or more of the components in FIG. 10 may not be present in any specific implementation. For example, some embodiments may not provide other computer readable media 1012 or display 1006.

Calendar tool 164 interacts via network 1020 with client devices 1022, physical computers 1026, and/or third-party systems/applications 1024. Client devices may include calendar applications 115A-N (shown in FIG. 1). The third-party systems/applications 1024 may include any systems that provide data to, or utilize data from, calendar tool 164 and calendar applications 115 A-N (shown in FIG. 1), including remote management/monitoring consoles, performance profilers, activity trackers, or the like.

As discussed, calendar tool assists in scheduling productivity based meetings as described with reference to FIGS. 1-9.

The architecture shown in FIG. 10 may in some embodiments be partially or fully virtualized. For example, computer system 1002 may be one or possibly many VMs executing on physical hardware and managed by a hypervisor, virtual machine monitor, or similar technology. Also, physical computers 1026 may include virtualization logic to manage multiple VMs.

In an example embodiment, components/modules of calendar tool 164 are implemented using standard programming techniques. In other embodiments, calendar tool 164 may be implemented as instructions processed by a VM that executes as one of other programs 1018.

Furthermore, in some embodiments, some or all of the components of calendar tool 164 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a non-transitory computer-readable storage medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques.

Further, from the foregoing it will be appreciated that, although specific embodiments have been described herein for purposes of illustration, various modifications may be made without deviating from the spirit and scope of this disclosure. For example, the methods, techniques, and systems for the productivity based meeting scheduler are applicable to other architectures or in other settings. For example, the described techniques may be employed as part of a cloud-based computing resource offering, wherein customers may pay to have higher importance levels associated with their activities, in order to obtain higher levels of service or availability. Also, the methods, techniques, and systems discussed herein are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

1. A method of scheduling a meeting using a productivity based meeting scheduler, the method comprising:
receiving a selection of two or more participants for a meeting requested by a meeting organizer, wherein the selection received on a calendar application is executed on one or more client devices;
determining participant information associated with each selected participant;
computing a time value of each selected participant based on the participant information; and
displaying the computed time value of each selected participant on at least one display screen of at least one of the client devices by the calendar application.

2. The method of claim 1, further comprising:
receiving a request to schedule the meeting based on the displayed computed time value of each selected participant; and
scheduling the meeting based on the received request.

3. The method of claim 1, wherein the participant information is selected from the group consisting of title, tenure, employee role, project/task priority, physical location, conflict with other tasks, calendar conflicts and time of task action.

4. The method of claim 1, further comprising:
computing a current expense incurred by scheduling the meeting by the meeting organizer based on the computed time value of each selected participant;
updating a stored previous expense incurred by previously scheduled meetings by the meeting organizer with the computed current expense incurred by scheduling the meeting;
updating a dashboard associated with the meeting organizer with the updated expense incurred by scheduling the meeting; and
displaying the updated dashboard upon receiving a request from the meeting organizer to view the dashboard.

5. The method of claim 4, further comprising:
determining a recommended time and location for scheduling the meeting based on the computed time value of each selected participant to the meeting organizer; and
displaying the recommended time and location on the display screen.

6. The method of claim 4, further comprising;
determining that the computed current expense exceeds a threshold expense value; and
displaying a warning message on the display screen in response to determining that the computed current expense exceeds the threshold expense value.

7. The method of claim 6, further comprising:
charging the computed current expense to the meeting organizer's cost center upon the computed current expense exceeding the threshold expense value.

8. The method of claim 6, further comprising:
displaying, on a display screen of a client device, a reward to the meeting organizer for scheduling the meeting when the computed current expense is equal to or below the threshold expense value.

9. The method of claim 4, further comprising:
displaying a recommendation for moving one or more selected participant's office to a different location to reduce the computed current expense based on past meeting history.

10. The method of claim 4, further comprising:
computing a current expense incurred by scheduling the meeting by the meeting organizer associated with a supervisor based on the computed time value of each selected participant;
updating a stored previous expense incurred by previously scheduled meetings by the meeting organizer associated with the supervisor using the computed current expense incurred by the scheduled meeting;
updating a dashboard associated with the supervisor with the updated expense incurred by scheduling the meeting by the meeting organizer associated with the supervisor; and
displaying the updated dashboard upon receiving a request to view the dashboard from the supervisor.

11. The method of claim 10, further comprising:
compiling expenses incurred by a plurality of meeting organizers associated with one or more other supervisors; and
displaying the compiled expenses associated with the one or more other supervisors.

12. A non-transitory computer-readable storage medium including instructions that are configured, when executed by a computing system, to perform a method for scheduling a meeting using a productivity based meeting scheduler, the method comprising:
receiving a selection of two or more participants for a meeting requested by a meeting organizer, wherein the selection received on a calendar application is executed on one or more client devices;
determining participant information associated with each selected participant;
computing a time value of each selected participant based on the participant information; and
displaying the computed time value of each selected participant on at least one display screen of at least one of the client devices by the calendar application.

13. The non-transitory computer-readable storage medium of claim 12, further comprising:
receiving a request to schedule the meeting based on the displayed computed time value of each selected participant; and
scheduling the meeting based on the received request.

14. The non-transitory computer-readable storage medium of claim 12, wherein the participant information is selected from the group consisting of title, tenure, employee role, project/task priority, physical location, conflict with other tasks, calendar conflicts and time of task action.

15. The non-transitory computer-readable storage medium of claim 12, further comprising:
computing a current expense incurred by scheduling the meeting by the meeting organizer based on the computed time value of each selected participant;
updating a stored previous expense incurred by previously scheduled meetings by the meeting organizer with the computed current expense incurred by scheduling the meeting;
updating a dashboard associated with the meeting organizer with the updated expense incurred by scheduling the meeting; and
displaying the updated dashboard upon receiving a request from the meeting organizer to view the dashboard.

16. The non-transitory computer-readable storage medium of claim 15, further comprising:
determining a recommended time and location for scheduling the meeting based on the computed time value of each selected participant to the meeting organizer; and
displaying the recommended time and location on the display screen.

17. The non-transitory computer-readable storage medium of claim 15, further comprising:
determining that the computed current expense exceeds a threshold expense value; and
displaying a warning message on the display screen in response to determining that the computed current expense exceeds the threshold expense value.

18. The non-transitory computer-readable storage medium of claim 17, further comprising:
charging the computed current expense to the meeting organizer's cost center upon the computed current expense exceeding the threshold expense value.

19. A computing system for scheduling a meeting, the system comprising:
one or more client devices; and
a virtual datacenter comprising:
multiple host computing systems, wherein each host computing system hosting multiple virtual machines (VMs);
a virtual management server communicatively coupled to the multiple host computing systems, wherein the virtual management server comprising virtualization management software (VMS), and
wherein the one or more client devices are communicatively coupled via Internet/Intranet to the VMS, wherein each client device includes a calendar application, and wherein one or more of the VMs include a calendar tool that is communicatively coupled to each calendar application, wherein the one or more calendar applications residing in the associated one or more of the client devices receives a selection of two or more participants for a meeting requested by a meeting organizer,
wherein the one or more calendar applications then obtains participant information associated with each selected participant from associated calendar tool,
wherein the associated calendar tool then computes a time value of each selected participant based on received participant information, and
wherein the associated one of the calendar applications then displays the computed time value of each selected participant to associated one of meeting organizers on at least one display screen of an associated one of the client devices.

20. The computing system of claim 19, wherein associated one of calendar applications then receives a request from associated one of meeting organizers to schedule the meeting based on the displayed computed time value of each selected participant, and
wherein associated one of calendar applications then schedules the meeting based on the received request from associated one of meeting organizers.

21. The computing system of claim 19, wherein the participant information is selected from the group consisting of title, tenure, employee role, project/task priority, physical location, conflict with other tasks, calendar conflicts and time of task action.

22. The computing system of claim 19, wherein the calendar tool further computes a current expense incurred by scheduling the meeting by the meeting organizer based on the computed time value of each selected participant, wherein the calendar tool further updates a stored previous expense incurred by previously scheduled meetings by the meeting organizer using the computed current expense incurred by the scheduled meeting, wherein the calendar tool further updates a dashboard associated with the meeting organizer with the updated expense incurred by scheduling the meeting, and wherein the calendar application further displays the updated dashboard upon receiving a request from the meeting organizer to view the dashboard on the display screen of the associated one of the client devices.

23. The computing system of claim 22, wherein the calendar application further determines a recommended a time and location for scheduling the meeting based on the computed time value of each selected participant to the meeting organizer, and wherein the calendar application further displays the recommended time and location on the display screen of the associated one of the client devices.

24. The computing system of claim 22, wherein the calendar application further determines that the computed current expense exceeds a threshold expense value, and wherein the calendar application further displays a warning message on the display screen of the associated one of the client devices in response to determining that the computed current expense exceeds the threshold expense value.

25. The computing systems of claim 24, wherein the calendar tool further charges the computed current expense to the meeting organizer's cost center upon the computed current expense exceeding the threshold expense value.
